(19) United States
(12) Patent Application Publication
(10) Pub. No.: US 2026/0103286 A1
(43) Pub. Date: Apr. 16, 2026

(54) DE-ICE CLEANER FOR AIRCRAFT

(71) Applicant: Gustavo Gomes Dell’Horto, Belo Horizonte (BR)

(72) Inventor: Gustavo Gomes Dell’Horto, Belo Horizonte (BR)

(21) Appl. No.: 19/095,653

(22) Filed: Mar. 31, 2025

Related U.S. Application Data
(60) Provisional application No. 63/706,239, filed on Oct. 11, 2024.

(51) Int. Cl. B64D 15/10

(52) U.S. Cl. CPC B64D 15/10

(57) ABSTRACT

A de-ice cleaner installed in front of landing gears of a vehicle such as an aircraft. The de-ice cleaner includes a retractable gun which uses high pressure of hot water against ice or snow on a runway, making a path in front of tires of the landing gears of the aircraft clear of snow or ice to prevent the aircraft from sliding and/or skidding off the runway. The de-ice cleaner has a flight plan setting provided for a particular destination, such as season and weather conditions of the runway. Once armed, the de-ice cleaner will turn on a heater during the landing procedure. Moments before touchdown on the ground, the retractable gun moves down from a cylinder and starts to apply a high-pressure jet of hot water or other liquid with the nozzles pointed directly at the path in front of the tires, allowing the tires to maintain a higher condition friction surface with the runway.

### CROSS REFERENCE TO RELATED APPLICATIONS

The present application claims priority to U.S. provisional patent application No. 63/706,239, filed Oct. 11, 2024. The entire contents of the above-referenced patent application are incorporated by reference herein.

### FIELD OF THE INVENTION

Aspects of the present invention relate to a de-ice cleaner having a hot water gun attached to a cylinder of a landing gear of an airplane, with an adapter attached to a main structure of the landing gear, wherein the de-ice cleaner provides a cleaner path during a landing on a runway having snowy or icy conditions.

### BACKGROUND

In a world where airplane trips are becoming more and more frequent, flights to countries where there are wintry conditions, such as snow and ice, will increase as well. Heavy snow or ice conditions are climatic conditions that have to be seriously considered for a flight plan. Most countries in North America, Europe and other parts of the world have to keep their airports operating even when poor weather conditions exist. However, those poor weather conditions bring more risks to flights, especially during the landings, and the snow may turn invisible and dangerous black ice is present.

Black ice is a thin covering of ice formed after snow melts and freezes again, making an invisible layer of ice due to asphalt of a runway underneath the black ice being common black or very dark, and hence the name black ice for this occurrence. Not only does black ice introduce problems during landing, but just snow is enough to cause an airplane to skid or slide, resulting in a potentially serious accident.

To land a small or a large airplane is not an easy task, even when a pilot has good weather conditions as viewed from the cockpit and a dry landing strip in front of the airplane. Nevertheless, pilots have to navigate difficult situations, especially during landing, when bad conditions often lead them to manually operate the aircraft. Sometimes, during snowy or icy conditions, the pilot may be told to turn the airplane back to the airport (location) where the trip started or to a closer airport because of bad weather conditions at the airport of arrival, including a snowy or icy runway.

These conditions may be known at the beginning of the trip during the flight plan set up or the bad weather conditions may be received by the pilot during the flight, possibly close to the destination. Some bad conditions must be faced as they cannot be avoided, and the best thing to do is taxi a couple or more times according to ground tower instructions or, as mentioned above, turning back to the airport of departure or being diverted to another airport, preferably nearby, with better runway conditions.

We have seen short videos and scenes of planes landing on snow. Even if the pilot is an expert and has hundreds of hours of flight time, the problem of tires of landing gears sliding or skidding on the runway occur, creating potentially dangerous situations.

20) Unfortunately, many landings have ended with horrible consequences. One example is Delta Flight 1086 landing at La Guardia Airport in New York on Mar. 5, 2015. Despite investigations which found the captain's inability to maintain directional control of the airplane due to his application of excessive reverse thrust as the main cause of the accident, the impact of snow conditions at the time cannot be discarded. A pilot has to be alert and prepared enough to avoid dangerous situations, in the event of failure of main systems and other emergencies situations during flights. Eliminating a weather related risk situation is desirable and, in this case, the accident of Delta Flight 1086 may have been avoided. In this case, all passengers that were interviewed after the accident told investigators that the airplane didn't grab the ground and skidded off to the left side, and the airplane struck a fence between the landing strip and the freezing waters of the Hudson River. There was almost a full-fledged tragedy.

Another typical case is the approaching of the airplane (more broadly, an airplane, aircraft to the parking area for the aircraft, where the tires frequently slide in a non-stop situation and can easily strike the areas near the runway where fuel trucks are parked, for example.

### BRIEF SUMMARY OF THE INVENTION

To address problems landing an aircraft such as snow or ice on a runway at an airport, an aspect of the present invention provides a de-ice track cleaner which includes a hot water gun positioned and retractable in a larger cylinder attached to a main body of a landing gear of the aircraft by an adapter. According to another aspect of the present intention, the hot water gun includes a group of nozzles pointed towards ground in front of a wheel of a landing gear, where nozzles of the hot water gun are activated and operated at different angles to remove and melt the snow or break the ice.

The de-ice track cleaner also includes a control panel positioned in the cockpit of the aircraft and allows the pilot to turn off, turn on, select destination weather conditions and arm the de-ice track cleaner to be ready for action with the heater working. The heater does not have to work from the time that the de-ice cleaner is started. The heater may be turned on, but in any case, an LED (arm light) will light on only when water in the heaters is at an appropriate temperature to be effective. There is also a ‘quick spray’ button to activate a hot jet for short distances or when the aircraft is approaching the parking area. This is done if the pilot wants to use de-ice cleaner manually after checking and determining that there is too much snow or ice on parking area or the approach from the runway to the parking area, to avoid sliding and skidding off of the runway or path to the parking area.

The de-ice track cleaner is powered by an electrical harness that connects to the heater to increase water temperature in a tank precisely sized and positioned close to other water tanks of the aircraft. Once the water is heated to a high enough temperature, but not so high as to evaporate, a water pump pressures the water through a duct attached to a cylinder to pass through the hot water gun and be applied on the ground under high pressure by nozzles that operate at different angles according to the conditions (snow or ice) of the runway/landing strip.

Additional aspects and/or advantages of the invention will be set forth in part in the description which follows and, in part, will be obvious from the description, or may be learned by practice of the invention.

### BRIEF DESCRIPTION OF THE DRAWINGS

Some embodiments of the present invention are illustrated as an example and are not limited by the figures of the accompanying drawings with the possibility of positioning the parts in different ways according to the model and size of the aircraft and more specifically, the kind and size of landing gears, in which like references may indicate similar elements and in which:

FIG. 1 illustrates an isometric view of a de-ice cleaner according to an aspect of the present invention.

FIG. 2 shows an expanded view of the de-ice cleaner shown in FIG. 1

FIG. 3 illustrates a perspective view of landing gear attached by an adapter to the de-ice cleaner shown in FIG. 1.

FIGS. 4A and 4B show a retractable gun in extended (down) and recoiled (up) positions, respectively.

FIG. 5A shows a lateral view of part of the de-ice cleaner; nozzles, the retractable gun, a cylinder, and an adapter, wherein a rod is attached to the end of the retractable gun, and different angles from an axis of the retractable gun that nozzles, attached in a line to the rod, may be directed.

FIG. 5B shows a lateral view of projection angles of water from each nozzle that can adjusted to act according to the landing strip conditions.

FIG. 6A shows a lateral view of the retractable gun, looking along the axis of the rod, where the rod is attached to the end of the retractable gun, and different angles in which nozzles, attached to the rod, can be rotated around an axis of the rod, and FIG. 6B is an enlarged view of the region A shown in FIG. 1.

FIG. 7 shows a control panel of the de-ice cleaner.

### DETAILED DESCRIPTION OF THE INVENTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

As noted above, significant problems arise for an aircraft to land on a runway which is not fully clear of snow and ice. As is well known, the snow or ice can cause tires of landing gears on the aircraft to slide or skid, risking the aircraft to move in an undesired direction, and possibly even off the runway.

It is generally not possible to slow down the airplane during landing, like one may slow down a car in similar conditions. Some actual weather conditions like snow and ice (including black ice), need to be handled, to make their impact irrelevant or minimal.

According to an aspect of the present invention, the snow or ice in advance (in front of) the tires of the landing gear is melted or broken in advance of the tires of the landing gear touching the runway.

According to an aspect of the present invention, one way to melt or break the snow or ice is to apply hot water at high pressure directly in front of the tires of the landing gears.

Even when the airplane is already on the ground, a quick jet can be used to get rid of the snow and ice on a small specific area in front of the tires.

Therefore, a need exists for a device that helps to totally avoid or minimize the snow and ice effects, providing a surface with more friction and consequently more control of the aircraft for the pilot, to vastly increase the ability of the pilot to make a safer landing. As a result, injuries to passengers and staff and damage to the aircraft can be prevented, with hot water applied at high pressure to guarantee a clean band in front of the tires.

The terminology used herein is for the purpose of describing particular embodiments only and is not intended to be limiting the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

According to an embodiment of the present invention, a de-ice track cleaner including a hot water gun is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

The present invention will now be described by example and through referencing the appended figures representing preferred and alternative embodiments.

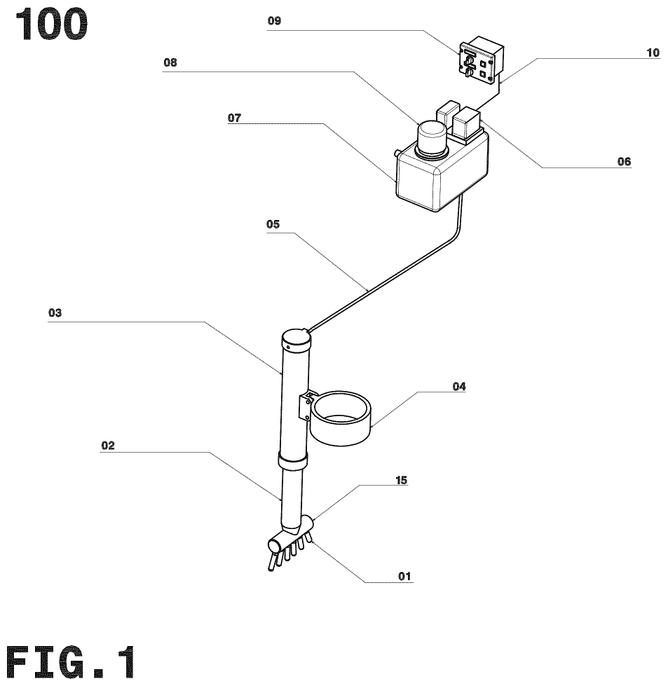

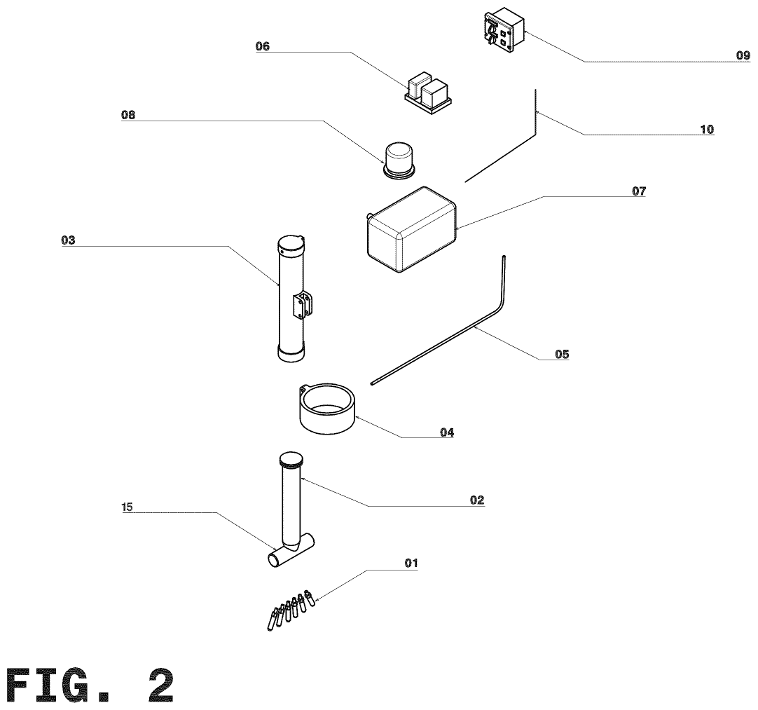

FIG. 1 illustrates an isometric view of a de-ice cleaner 100 according to an aspect of the present invention. An interface control panel 9 Is located in a cockpit of an aircraft (not shown), where the pilot or co-pilot of the aircraft (such as, but not limited to, an airplane) can turn on or (ii) turn off the de-ice cleaner 100. According to the flight plan of the aircraft, the destination is set by the crew and the crew is informed of the weather conditions at the destination airport via the Internet or by the flight control at the destination airport. If the weather conditions predict no snow or ice, then the pilot or operator can turn the de-ice cleaner 100 off. If the destination is predicted to have snow or ice, then the de-ice cleaner is turned on and then the de-ice cleaner 100 can be (iii) armed which means that the de-ice cleaner 100 is ready to automatically activate a heater 6 some period time, perhaps a few minutes, depending upon the aircraft model and water tank capacity, before the landing when the aircraft starts the procedures to approach of the airport of destination. At this point, the heater 6 starts to heat water stored in a hot water tank 7, and which is powered by electrical energy from an electrical harness system 10. The electrical harness 10 is connected to the heater 6 to increase water temperature in the hot water tank 7 and positioned close to other water tanks of the aircraft.

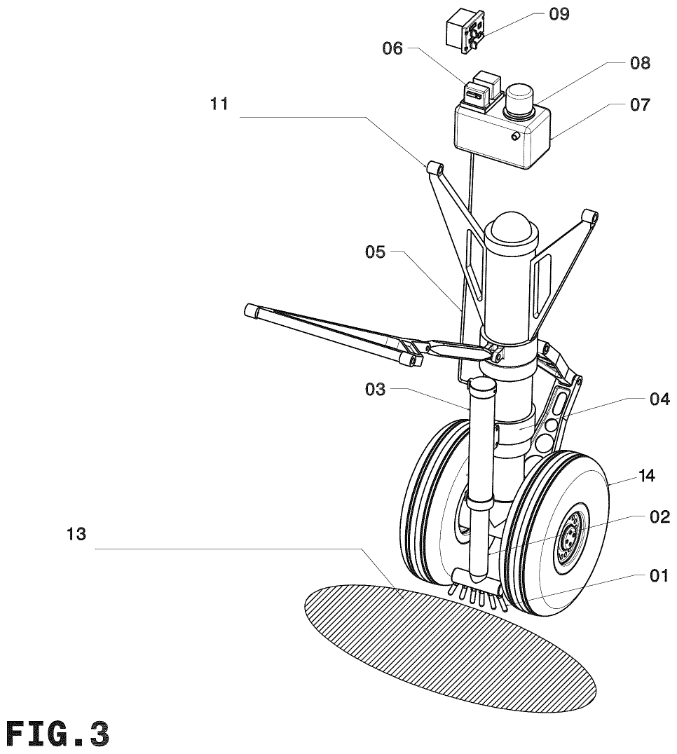

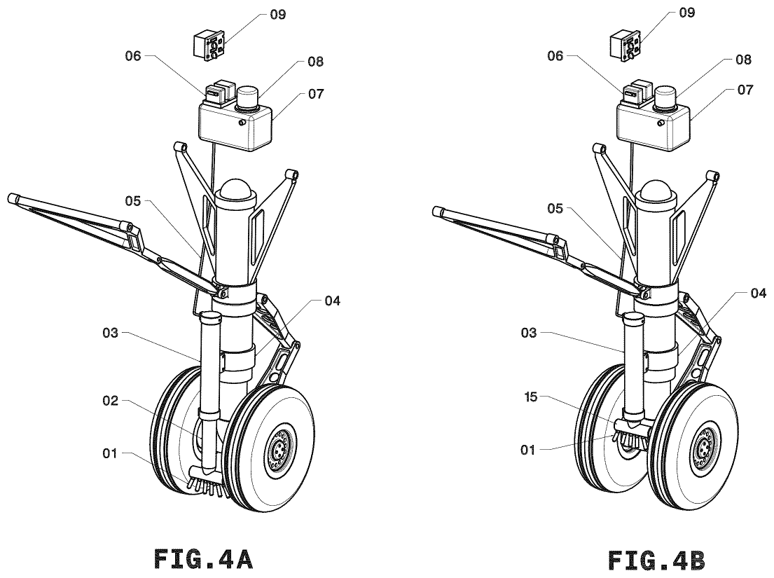

The present invention contemplates that other liquids and/or other ingredients, including fluids that can be heater faster, can be used instead of water. If the de-ice cleaner 100 is turned off, nothing will happen, and all of the elements of the de-ice cleaner 100 will not move or act. If the de-ice cleaner 100 is turned on and armed minutes before the landing, the heater 6 acts to heat the water in the hot water tank 7. After that, closer to the ground and 10 meters (10 meters being just an example of the distance, and other distances May be implemented) from touch down considering the distance from the ground to tires 14 of a landing gear 11 (see FIGS. 3 and 4A-4B), a sensor (not shown) activates a retractable gun 2 in a fully extended position from a cylinder 3. The sensor may be a part of the Instrumental Landing System—ISL—that already exists on airplanes. They would communicate with the de-ice cleaner to activate the latter at the correct time. About 1 meter from touch down on the runway, another sensor (not shown) senses a distance from the ground of 6 meters to point the nozzles, and at one meter, activates a water pump 8 to produce a high-pressure injection of hot water through a duct 5, so that the water will pass through the nozzles 1 and will melt and/or break up snow and ice and provide clean tire bands in front of the tires 14. A cylinder 3, connected to the duct 5, holds the retractable gun 2, and enables the retractable gun 2 to retract into and expand out of the cylinder 3.

FIG. 3 illustrates a perspective view of the landing gear 11 attached by an adapter 4 to the de-ice cleaner 100, enabling the landing gear 11 and the de-ice cleaner 100 to operate in conjunction with each other. With the operation of the de-ice cleaner 100, a clean band free from snow or ice is provided in a hot water projection area 13 in front of the tires 14.

FIGS. 4A and 4B show the retractable gun 2 in extended (down) and recoiled (up) positions, respectively. In the extended position, the nozzles 1 are moved closer to asphalt of the runway (landing strip) to be more effective with the water jet application.

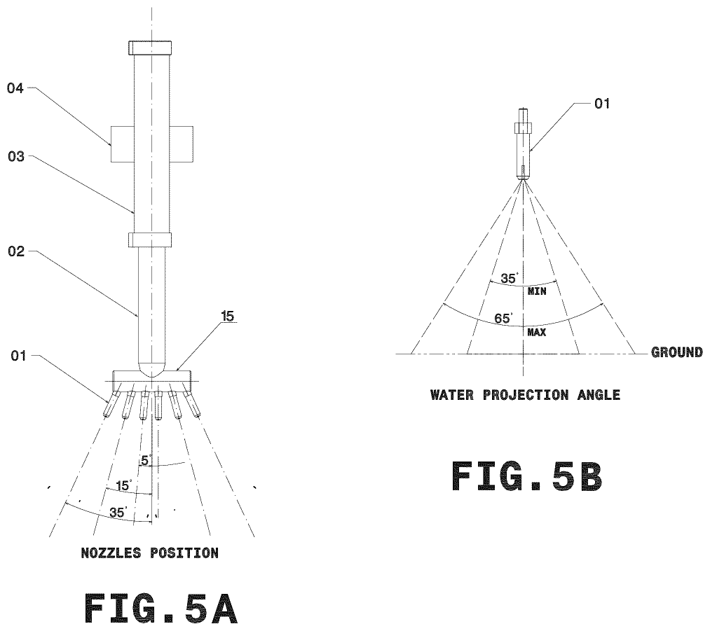

FIG. 5A shows a lateral view of part of the de-ice cleaner 100; the nozzles 1, the retractable gun 2, the cylinder 3, the adapter 4, and the rod 15. The rod 15 is attached to the end of the retractable gun. The nozzles 1 are mounted to the rod 15 in a linear (although not required) fashion, The number of nozzles 1 mounted on the rod 15 can be varied, taking into account a variety of factors, such as the landing gear size and the aircraft model. The nozzles 1 are mounted at different angles relative to an axis of the retractable gun 2, so that the nozzles 1 eject the hot water at different angles relative to the axis of the retractable gun 2. Here, by way of example, angles of the nozzles 1 relative to the axis of the rod 15 are fixed, and jets of the hot water from the nozzles 1 closer to the center of the rod 15 are more concentrated than the jets of hot water from the nozzles 1 towards the ends of the rod 15. As shown in FIG. 5A, the angles range from 5-35° relative to the axis of the rod 15.

FIG. 5B shows that the angle/direction of each nozzle 1 can be adjusted through the pilot's control to act according to the landing strip conditions. If there's snow, the single nozzle 1 will act in a larger and less concentrated angle of 65°, for example, providing a larger band. If there is an ice condition, a harder jet with a more concentrated projection, such as an angle of 35°, for example, may be utilized.

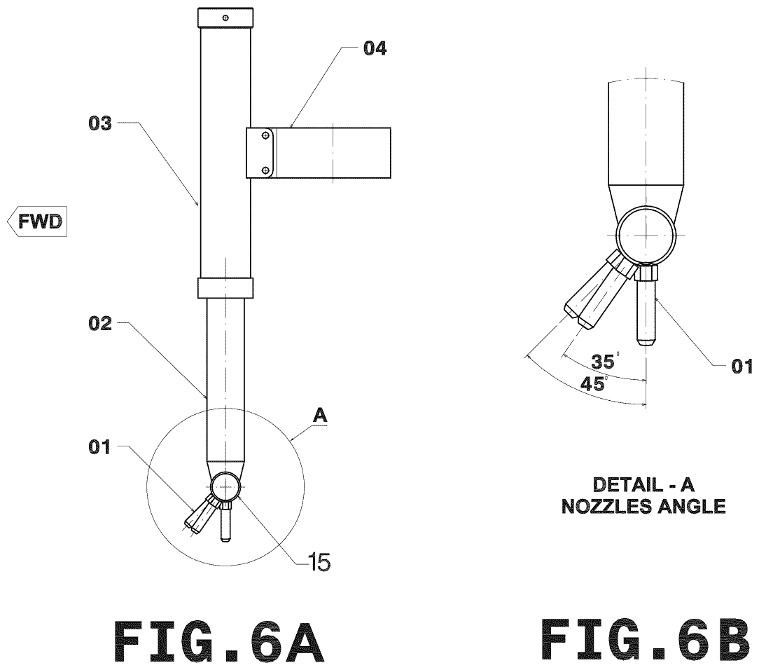

FIG. 6A shows a lateral view of the retractable gun 2, looking along the axis of the rod 15, where the rod 15 is attached to the end of the retractable gun 2 and is rotatable relative to the retractable gun.2. The axis of rotation of the rod 15 is perpendicular (although not required to be perpendicular) to the axis of the retractable gun 2. The rod 15 is rotatable relative to the axis of the retractable gun to rotate the nozzles 1 to change the direction of the nozzles 1 relative to the tires 14, so as to be less or more forward pointing relative to the tires 14. The rod 15 is rotated to adjust the degree that the nozzles 1 are pointed forward relative to the tires 15 according to weather conditions.

Before a tire 14 of the landing gear 11 touches the ground, the retractable gun 2 is moved downward in the direction of the runway/the asphalt about 10 m above the runway/asphalt, positioning the nozzles 1 closer to runway to make a more effective cleaning area, and the retractable gun starts ejecting the hot water when the tire 14 is about 1 M above the runway, so as to provide a clean path for the tire 14 to grab the asphalt efficiently and avoid sliding or skidding off of the aircraft on the runway. This operation permits the tires 14 to touch the ground and enable grabbing of wet asphalt instead of snow or ice at a friction coefficient condition around 5 times higher (from 0.15 to 0.70) according to Table 1 below:

TABLE 1

| | Kinetic | Static |
|---|---|---|
| Materials and Material | Frictional | Frictional |
| Combinations | Coefficient | Coefficient |
| Rubber on concrete (dry) | 0.6-0.85 | 0.9 |
| Rubber on concrete (wet) | 0.45-0.75 | — |
| Rubber on asphalt (dry) | 0.5-0.8 | 0.85 |
| Rubber on asphalt (wet) | 0.25-0.75 | — |
| Rubber on ice | 0.15 | — |

The temperature of the water ejected from the nozzles 1 is approximately at a minimum 67° Celsius and less than 100°. The pressure of the water ejected from the nozzles is sufficient to melt the snow or ice as necessary.

The above-described angles of the nozzles shown in FIG. 5A and the adjustments of the nozzles 1 shown in FIGS. 5B, 6A and 6B work together. The projection of water from the nozzles 1 for snow conditions is 65° (FIG. 5B) combined with 45° of nozzle angle position relative to the axis of the retractable gun 2 (FIG. 6B). For ice conditions, the projection of water from the nozzles 1 is 35° (FIG. 5B) combined with a nozzle angle position relative to the axis of the retractable gun 2 of 35° (FIG. 6B). In any case, both angles for positions of the rod 15 and the nozzles 1 and projections of the water from the nozzles are automatically set by the selection on the control panel 9 after the de-ice cleaner 100 is turned on and the weather conditions at the destination are verified.

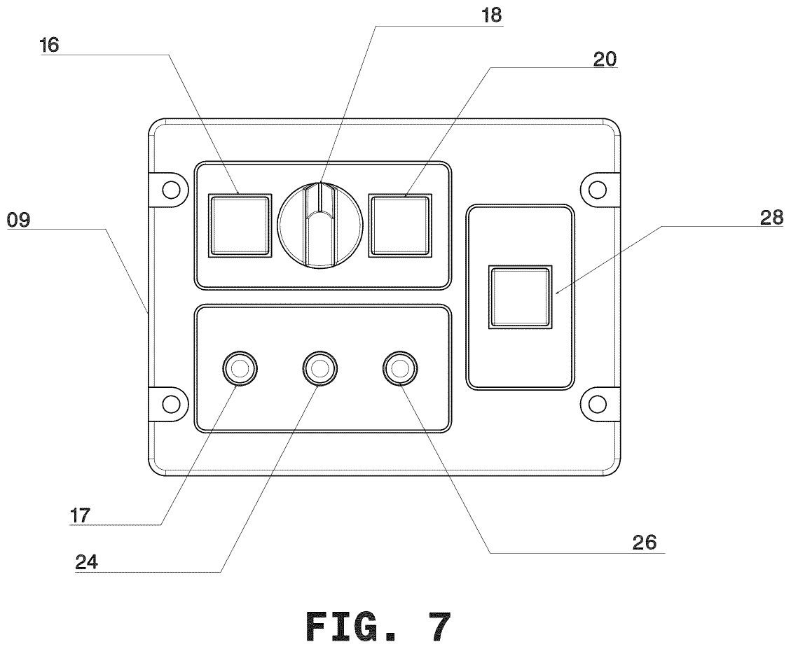

FIG. 7 illustrates an interface of the control panel 9. The button 16 turns on or off the de-ice cleaner 100. Other methods of turning on or off the de-ice cleaner 100 can also be used, such as a switch, by a remote control device, etc. The use of the de-ice cleaner 100 is determined based upon the weather conditions at the destination set by the flight plan. Once this is done, the pilot will check the weather conditions manually by other sources he/she has access to according to the type of aircraft operated or the aircraft system can do the same automatically, alerting the pilot or co-pilot, who will decide whether to turn the de-ice cleaner 100 on or not. Once determined and confirmed that the snow or ice conditions are intense enough, the pilot will turn on the de-ice cleaner 100 using the button 16. Once this is done and also according to complementary weather information, the pilot will select snow or ice on a selector 18. At this point, as the aircraft still has not taken off, only the LED of activation of the button 16 will light up on the control panel 9. After take-off, and the de-ice cleaner 100 is ready to work, as the aircraft approaches its destination, the de-ice cleaner 100 will be armed automatically as indicated on the armed LED 20. If the de-ice cleaner 100 does not arm automatically, the armed LED 20 can be pushed to do it by the pilot as an alternative and emergency action is taken. When the water temperature in the hot water tank 7 gets higher, say a minimum of 67°, but low enough to not evaporate, a heater LED 22 will change color so that the pilot can confirm the water is at the right temperature to work at maximum performance to melt snow or break ice. If a problem occurs that the temperature is not high enough, the de-ice cleaner 100 can still be used, but at a less efficient level.

The control panel 9 has a low water level LED indicator 24 to indicate whether the level of water in the hot water tank 7 is low. In this case, the information must be reported to ground staff members to refill the hot water tank 7 or the hot water tank 7 can be refilled by a central water tank on the aircraft depending on the aircraft model. The extension of the retractable gun 2 with the nozzles 1, at this point, can be verified by a hot water gun extension LED indicator 26. As an additional feature, a manual quick jet can be activated by the quick jet activation button 28. In this case, if the aircraft is approaching the parking area or making small curves (sliding) over the snow or ice, the pilot can optimize the effectiveness of the de-ice cleaner 100.

The de-ice cleaner 100 will work automatically after being armed by the button 16. As described above, the retractable gun 2 will extend downward from the cylinder 3 when the aircraft is 10 meters off the ground and will start ejecting the hot water from the nozzles 1 when the aircraft is 1 meter off the ground. The numbers can depend upon the speed and type of the aircraft. These activations work in conjunction with the sensors that already exist on the aircraft.

The de-ice cleaner 100 will stop operating when the aircraft is deemed to be controllably on the runway, at a less than critical speed and free of aerodynamic forces. At this point, the retractable gun 2 will stop spraying hot water through the nozzles, but will remain in the extended downward position so the quick jet activation button 28 can be used anytime until the aircraft is completely stopped.

When the engines of the aircraft are stopped, the de-ice track cleaner 100 is turned off and reset. At this point, the retractable gun 2 is withdrawn fully into the cylinder 3. The next use will depend on another flight plan set and new weather conditions determined according to the next destination.

Although the present invention has been illustrated and described herein with reference to preferred embodiments and specific examples thereof, it will be readily apparent to those of ordinary skill in the art that the disclosed embodiments are merely examples of the invention, and that other embodiments and examples may perform similar functions and/or achieve like results. All such equivalent embodiments and examples are within the spirit and scope of the present invention, are contemplated thereby, and are intended to be covered by the following claims.

1. A de-ice track cleaner to be placed on a landing gear of a vehicle having a main body and a tire, the de-ice track cleaner comprising:
a tank which holds a liquid,
a heater to heat the liquid;
a pump;
a cylinder;
an adapter to attach the cylinder to the main body and in front of the tire;
a duct;
a retractable gun to extend from and retract into the cylinder;
a rod connected to an end of the retractable gun; and
a plurality of nozzles affixed to the rod;
wherein:
the pump pumps the heated liquid through the duct from the tank to the retractable gun;
the retractable gun, when extended from the cylinder, ejects the heated liquid through the rod and the plurality of nozzles, so that the plurality of nozzles spray the heated liquid in front of the tire as the tire rotates to move the vehicle in a forward direction.

2. The de-ice track cleaner as claimed in claim 1, wherein the plurality of nozzles spray the heated liquid as steam and under a pressure high enough to melt snow or ice that is in front of the tire as the tire rolls forward.

3. The de-ice track cleaner as claimed in claim 1, wherein the plurality of nozzles are affixed in a linear fashion to the rod, and the plurality of nozzles emit the heated liquid with a projection angle.

4. The de-ice track cleaner as claimed in claim 3, wherein a range of the projection angle is adjustable to a range between 35-65° C.

5. The de-ice track cleaner as claimed in claim 1, wherein the plurality of nozzles are linearly affixed to the rod, and are arranged at different angles relative to an axis of the retractable gun in a plane including the axis of the retractable gun and the axis of the rod.

6. The de-ice track cleaner as claimed in claim 5, wherein a maximum of the angles is 35° C.

7. The de-ice track cleaner as claimed in claim 1, wherein the plurality of nozzles are affixed in a linear fashion to the rod, the rod is rotatable relative to the retractable gun to adjust an angle that the plurality of nozzles emit the heated liquid in front of the tire.

8. The de-ice track cleaner as claimed in claim 1, wherein the angle that the rod rotates the plurality of nozzles to emit the heated liquid in front of the tire within a range of 35°−45° C.

9. The de-ice track cleaner as claimed in claim 3, wherein the rod is rotatable relative to the retractable gun to adjust a direction angle that the plurality of nozzles eject the heated liquid in front of the tire.

10. The de-ice track cleaner as claimed in claim 1, further comprising a controller to extend the retractable gun from the cylinder when the vehicle is a first distance from a runway, and ejects the heated liquid from the plurality of nozzles when the vehicle is a second closer distance from the runway.

11. The de-ice track cleaner as claimed in claim 9, further comprising a controller to extend the retractable gun from the cylinder when the vehicle is a first distance from a runway, and ejects the heated liquid from the plurality of nozzles when the vehicle is a second closer distance from the runway.

12. The de-ice track cleaner as claimed in claim 10, further comprising a controller to extend the retractable gun from the cylinder when the vehicle is a first distance from a runway, and ejects the heated liquid from the plurality of nozzles when the vehicle is a second closer distance from the runway.

13. The de-ice track cleaner as claimed in claim 9, wherein, according to a weather condition of a runway at a destination point of the vehicle:
the controller
adjusts the projection angle that the plurality of nozzles eject the heated liquid;
rotates the rod to adjust the direction angle of the plurality of nozzles, to adjust how far in front of the tire that the heated liquid is directed to the runway.

14. The de-ice track cleaner as claimed in claim 13, where the projection angle is higher when the weather condition is snow than when the weather condition is ice; and

15. A de-ice track cleaner which receives heated liquid, comprising:
a cylinder;
a retractable gun to extend from and retract into the cylinder;
a rod connected to an end of the retractable gun; and
a plurality of nozzles affixed to the rod;
wherein:
the retractable gun receives the heated liquid, and when extended from the cylinder, ejects the heated liquid through the rod and the plurality of nozzles, so that the plurality of nozzles spray the heated liquid at an angle relative to an axis of the retractable gun.

16. The de-ice track cleaner as claimed in claim 15, wherein the plurality of nozzles are affixed in a linear fashion to the rod, and the plurality of nozzles emit the heated liquid with a projection angle in a range 35°−65° C.

17. The de-ice track cleaner as claimed in claim 15, wherein the plurality of nozzles are affixed in a linear fashion to the rod, and the rod is rotatable relative to the retractable gun to adjust the angle that the plurality of nozzles spray the heated liquid relative to the axis of the retractable gun.

18. The de-ice track cleaner as claimed in claim 16, wherein the plurality of nozzles are affixed in a linear fashion to the rod, and the rod is rotatable relative to the retractable gun to adjust the angle that the plurality of nozzles spray the heated liquid relative to the axis of the retractable gun.
